(19) United States
(12) Patent Application Publication
(10) Pub. No.: US 2009/0279778 A1
(43) Pub. Date: Nov. 12, 2009

(54) METHOD, A SYSTEM AND A COMPUTER PROGRAM FOR DETERMINING A THRESHOLD IN AN IMAGE COMPRISING IMAGE VALUES

(75) Inventor: Ahmet Ekin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,431

(22) PCT Filed: Jun. 19, 2007
(86) PCT No.: PCT/IB07/52346

§ 371 Date: Dec. 18, 2008

(30) Foreign Application Priority Data
Jun. 23, 2006 (EP) 06115949.7

(51) Int. Cl. G06K 9/00

(52) U.S. Cl. 382/170

(57) ABSTRACT

The invention relates to a method (1) for determining a threshold in an image comprising image values, said method comprising the steps of: analyzing (3) the image values for determining edge points and associated gradients; classifying (5) image values into classes with respect to the edge points; obtaining (7) image threshold by combining data from the intensity histograms calculated for each class with statistical analysis of the said histograms. The invention further relates to a method of image segmentation, an image processing system and a computer program.

### FIELD OF THE INVENTION

The invention relates to a method for determining a threshold in an image comprising image values.

The invention further relates to a method of image segmentation.

The invention still further relates to an image processing system for analyzing an image comprising image values.

The invention still further relates to a computer program.

### BACKGROUND OF THE INVENTION

The method for determining a threshold in an image as is set forth in the opening paragraph is known from EP 1 320 069 A2. In the known method use is made of an image analysis step wherein all image pixels are used to construct the image intensity histogram, after which a threshold in the image is determined by assigning a predetermined percentage N of pixels as belonging to a sought object. The value N is then used to compute the intensity value that corresponds the predetermined percentage of selected pixels using a cumulative distribution function.

It is a disadvantage of the method known from the prior art that it provides inaccurate results for non-uniformities in the image due to an intrinsic significant overlap of pixel values corresponding to different regions in the image.

### SUMMARY OF THE INVENTION

It is an object of the invention to provide a method for determining a threshold in the image, whereby improved classification results are enabled for a wide range of image types and image contrasts.

To this end, the method according to the invention comprises the steps of:

analyzing the image values for determining edge points and associated gradients;

classifying image values into classes with respect to the edge points;

obtaining image threshold by combining data from the intensity histograms calculated for each class with statistical analysis of the said histograms.

The method according to the invention, thus first detects class borders, defined as edges, and constructs two histograms by using the data points on either side of the border. Afterwards, a statistical analysis is performed based on the respective histograms, which approximate the probability distribution function. The threshold in the image is then calculated to be based on the histograms and their statistical analysis to minimize the number of misclassified labels for the selected image values. The method according to the invention has the following advantages. First, it is able to compute the threshold value even when the classes are significantly merged. Secondly, the method according to the invention uses spatial information present in the image. Third, no assumptions about a number of class members present in the image is made, which is crucial to the robustness of the method. Finally, for medical images, like, for example, magnetic resonance images, the method according to the invention is robust with respect to the partial volume effect and intensity nonuniformity (bias field).

In an embodiment of the method, the step of analyzing the image values comprises a step of computing image contrast and adaptively determining the edge gradient threshold to the computed image contrast.

This embodiment operates as follows. First, the contrast in the image, or a region, as defined in Equation 1 is computed, where \vec{x} and \vec{y} denote N-dimensional spatial coordinates (3-D for medical data), and R is a region that may be the whole image or a region defined with a mask. According to Equation 2, the computed contrast value determines the edge threshold value, T_{edge}, which is automatically adapted to the image content. The parameter k is a pre-determined constant, such as 0.1, that reflects what proportion of the contrast value should be regarded as necessary for edge detection. If the multiplication of the contrast value with k results in a value that is smaller than one, Equation 2 assigns one as the T_{edge} value. Afterwards, class borders are detected by comparing the gradient magnitude, computed as in Equation 3, with the edge threshold (as shown in Equation 4). The parameter Δ in Equation 4 determines the step size and the edge direction. When there is no partial volume effect (PVE), the magnitude of Δ can be equal to one. Otherwise, a value greater than one should be used so that PVE has less effect in the compared pixel locations.

C=max(I(\vec{x});\vec{x}εR)−min(I(\vec{y});\vec{y}εR) (1)

T_{edge}=max(k*C,1) (2)

G(\vec{x})=|I(\vec{x}+Δ)−I(\vec{x}−Δ)| (3)

$$E ( \vec{x} ) = \{ \begin{matrix}1 & if G ( \vec{x} ) \geq {T}_{edge} \\ 0 & otherwise\end{matrix} \qquad ( 4 )$$

It is noted that a further improvement of the approach given in Equation 1, which uses the difference between maximum and minimum values for the contrast, can be found when the input data, notably an image, is filtered for removing noise prior to application of Equation 1 to it. Another way of improvement is to compute histogram of the intensity values using all pixels or voxels in the image. Then, a difference between Nth and Kth=(100−N)th percentile represents contrast. N could be set to 95th percentile, while Kth to the 5th, for example. other combinations for contrast derivation (Nth=90; Kth=10; Nth=80, Kth=20, etc.) are contemplated as well.

It is further noted that Equation 3 preferably is not limited to one orientation in the image data. By using multiple delta's, computed, notably for three orthogonal directions, and by subsequently choosing a single delta with maximum value, the robustness of the method according to the invention is further improved.

Finally, it is noted that in order to eliminate large contribution of data from one region of the image upon overall performance of the method according to the invention, it is possible to limit the maximum and minimum number of edge points that can be contributed from distant spatial regions. For instance, if the image is spatially divided into four quadrants, it is possible to set a condition that each region is allowed to contribute substantially the same or close number of edge pixels/voxels to the respective histograms H_{L} and H_{U}. This technical measure ensures reduced influence of particular regions on the overall performance of thresholding method according to the invention.

In a further embodiment of the method according to the invention the step of classifying image values into classes with respect to the edge points comprises the steps of:

determining edge orientation for each edge point;

determining pairs of values in the image defining the said edge points and the said orientation;

using a pre-defined criterion to distribute the said values into different classes.

For each detected border point, two data points that are used in Equation 3 are selected. Preferably, a magnitude comparison between respective image values is performed, for example, an image value (pixel or voxel) with a larger intensity can be assigned to the first histogram, whereas the image value with the lower intensity is assigned to the second histogram. Due to the fact that these image values are selected across the edge along the gradient direction, there always be a difference in their respective magnitude. Consequently, these points are assigned to two separate histograms, H_{L} and H_{U}, whereby the smaller intensity value is assigned to the former and the larger one to the latter. In this way, we select equal number of points from each class. In the final step, the cumulative distribution functions (C) of the two classes is computed. Assuming normalized histograms approximate the probability density, they can be computed as in Equation 5.

$${C}_{L} ( u ) = {\sum }_{i = 0}^{u} {H}_{L} ( i ) \qquad ( 5 )$$

In a still further embodiment of the method according to the invention the step of obtaining image threshold comprises the steps of:

computing normalized intensity histograms for the each thus formed class;

computing respective cumulative distribution function corresponding to each class;

determining the image threshold using the said cumulative distribution functions.

In accordance with Equation 6, the threshold value, T, is computed to maximize the sum of the correct decisions for the representative samples that are close to the boundary. In a further embodiment, the distance of the threshold value, T, to the peak locations of H_{L} and H_{U} are computed. When the computed T value is much closer to one of the peak locations than the other, a better location that can be closer to the mid-point between the two peaks is searched. To replace the computed T value, the new location should result in a difference value that is close to the maximum difference, e.g. at least 90% of it, obtained with the original T value computed by Equation 6.

$$T = arg {max}_{I} ( {C}_{L} ( I ) - {C}_{H} ( I ) ) \qquad ( 6 )$$

In a still further embodiment of the method according to the invention a predetermined feature is selected for the allowable outcome of the statistical analysis, the method further comprises the steps of:

computing a plurality of local contrast edges;

classifying image values into classes with respect to the said plurality of local contrast edges for forming a plurality of respective local intensity histograms;

obtaining a plurality of local image thresholds by combining data from the said plurality of intensity histograms calculated for each class with statistical analysis of the said plurality of intensity histograms.

This embodiment has an additional advantage, namely the method can evaluate the segmentation error resulting from the application of the computed threshold value by the proposed method to a predetermined value. In addition to or instead of global analysis, the above operations can be performed locally. The local application allows for applying locally optimum threshold values, which in many cases result in superior results than the global threshold. The local analysis also allows for comparison of several statistics extracted from histogram statistics to decide whether certain effects in the image are present. For example, MR images may suffer from intensity non-uniformity (also referred as bias field) that results from device parameters, scanning protocol, and patient features. Bias field is a non-uniform multiplicative field and causes the intensity values of different tissues to overlap.

In a still further embodiment of the method according to the invention, wherein a plurality of regions of interests is defined within the image, the classification of image values being performed for each region of interest and the threshold being established based on analysis of respective histograms and statistics for each selected region of interest.

This technical measure is based on the insight that it is also possible to apply classification steps to one region of interest (ROI) in the image and to compare the statistics extracted from that with the statistics of another ROI. Multiple ROIs can be defined in an image, statistics can be extracted from each ROI analysis, and the collection of such statistics in all ROIs can be used for further analysis, such as bias field estimation. The ROI can be the whole image, any shape defined by a mask (a collection of such unconnected regions also), or blocks defined by mathematical formulations with small number of parameters, such as rectangles, squares, or circles.

A method of image segmentation according to the invention comprises a method for determining a threshold in an image as is described with reference to the foregoing. The method according to the invention is in particular highly valuable for processing magnetic resonance images, notably of brain. For purpose of segmenting a magnetic resonance brain image, it is necessary to classify brain tissue into two classes: cerebrospinal fluid (CSF) and white matter-grey matter (WM-GM). A suitable input image is a 3D skull-stripped brain MR image, wherein no assumptions about the available contrasts, such as T1 and T2 are made in accordance with the invention. The skull stripping can be done by applying one of the publicly available tools, such as, for example S. Smith, BET2: Brain extraction tool, University of Oxford http://www.fmrib.ox.ac.uk/fsl/bet2/.

Once CSF is extracted, the separation of WM and GM can be performed. The reasons for doing this are that: 1) the contrast between WM and GM is usually less than the contrasts between each of WM and GM, and CSF in many MR contrasts. In an MR scan with non-optimal parameter settings, WM and GM may end up as one cluster in a straightforward clustering algorithm, and 2) abnormalities may affect the magnetic properties of WM and GM. This makes finer analysis of WM and GM regions necessary. For example, large amounts of iron accumulation change the T2 characteristics of basal ganglia and result in hypo-intensities in those regions.

The segmentation method according to the invention uses the thresholding method as is discussed with reference to the foregoing to label WM and GM. After applying the thresholding method, the decision about labeling the two regions as WM and GM may use the knowledge about their expected relative intensity values. For example, the region with the higher intensity value is assigned as WM if T1-weighted images are used. The relative locations of WM and GM tissues can also be used for this purpose, e.g., GM has a peripheral region surrounding the CSF.

Preferably, for images with substantially reduced contrast, the segmenting method according to the invention computes local adaptive thresholds by using locally computed histograms.

The image processing system according to the invention comprises a computer with a processor arranged for:

determining contrast edge points by analyzing gradients in the pixel values within the image;

classifying image pixels with respect to the contrast edge thereby seeding respective intensity histograms;

computing respective probability mass functions corresponding to each of the said histograms;

determining the image threshold using the said probability mass functions.

The image processing system according to the invention provides an accurate and robust tool for image processing and may be suitably incorporated, notably in a hospital information system for image analysis. The image processing system will be further discussed with reference to FIG. 3. Further advantageous embodiments of the image processing system are set forth in claim 6, 7.

These and other aspects of the invention will be apparent from and elucidated with reference to embodiments described hereinafter.

### DESCRIPTION OF THE DRAWINGS

FIG. 1 presents in a schematic way an embodiment of the thresholding method according to the invention.

FIG. 2 presents in a schematic way an embodiment of operational steps of the cumulative distribution function.

FIG. 3 presents a schematic illustration of the effect of the bias filed on respective histogram peaks.

FIG. 4 presents in a schematic way an embodiment of an image processing system according to the invention.

FIG. 5 presents in a schematic way an embodiment of a flow-chart of a computer program according to the invention.

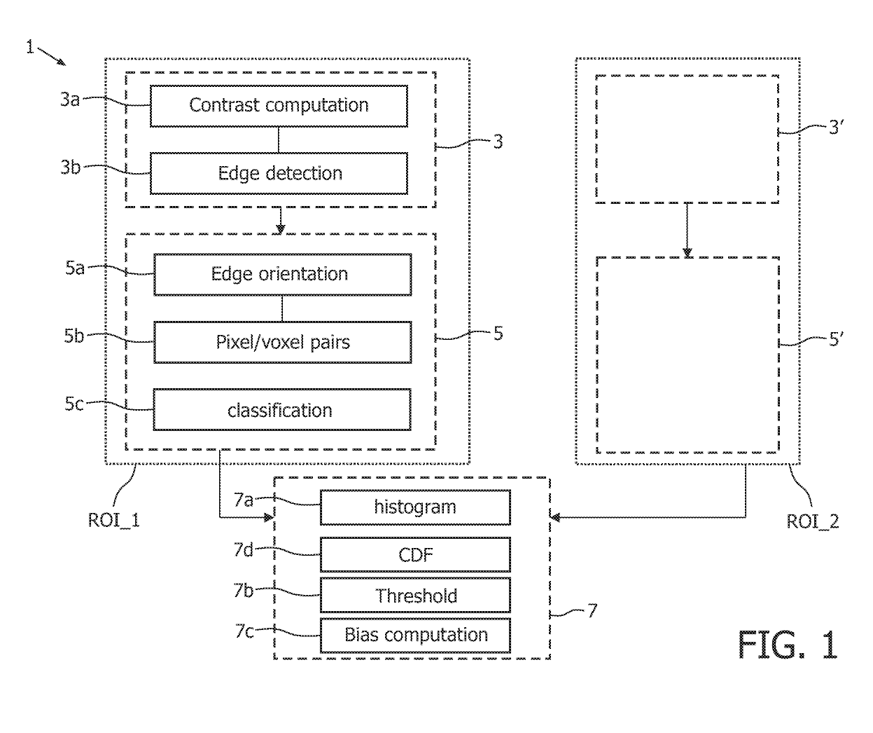

FIG. 1 presents in a schematic way an embodiment of the thresholding method according to the invention. The method 1 according to the invention is arranged to analyze image values (pixels or voxels) of an image under consideration for determining edge points and gradients associated with them at step 3. This can advantageously be performed by computing image contrast at step 3a, for example in accordance with Equation 1, which is given above. Subsequently, at step 3b a suitable edge detector can be used for determining edge points, followed by determination of edge orientation at step 5a. Subsequently, suitable pairs of pixels or voxels 5b located at different sides of the edge are selected. At step 5 of the method according to the invention the thus selected voxel or pixel pairs are classified, preferably by using a pre-determined classification order. For example, a classifier 5c may be used, whereby pixels or voxels are classified into two classes in accordance with their respective absolute magnitude. The method according to the invention proceeds to step 7, wherein the image threshold is obtained by combining data from the intensity histograms calculated for each class with statistical analysis of these histograms. Preferably, the respective histograms are built by analyzing entries of the two classes of pixels or voxels at step 7a. The threshold is then calculated at step 7b by maximizing a sum of the correct decisions for representative samples that are close to the edge, for example in accordance with Equation 6, discussed above, using cumulative distribution function 7d.

The method according to the invention is superior with respect to the methods known from the prior art, notably because it is able to separate classes that have very close centers, it uses both spatial and feature-space information and it can handle soft class membership, i.e. a feature value that does not have binary membership value. Finally, the method according to the invention is superior in its speed of operation.

It is noted that due to the fact that the method according to the invention having a statistical basis, it is not limited to one application. Although herewith the border between classes is computed with relation to spatial image information, it can be defined in many other ways for non-image data. For non-image data, class-to-class transitions can be detected in either a specific way to the application or by using differences. Once they are determined, the histograms could be filled similarly. Preferable applications for image-related data comprise any of the following: processing of infrared imagery as the contrast in this type of data varies with the ambient temperature; processing of medical images where significant variations in contrast arises from particular imaging protocol; general video data with low contrast; molecular imaging with contrast agents showing differences in the image contrast.

It is further noted that the method according to the invention in general may be initiated on any region of interest within the image (ROI), which may be referred to as global analysis. In particular cases, in addition to or instead of global analysis, the above operations can be performed locally. The local application allows applying locally optimum threshold values, which in many cases result in superior results than the global threshold. The local analysis also allows for comparison of several statistics extracted from the histogram statistics to decide whether certain effects in the image are present. For example, MR images may suffer from intensity non-uniformity (also referred as bias field) that results from device parameters, scanning protocol, and patient features. Bias field is a non-uniform multiplicative field and causes the intensity values of different tissues to have more overlap.

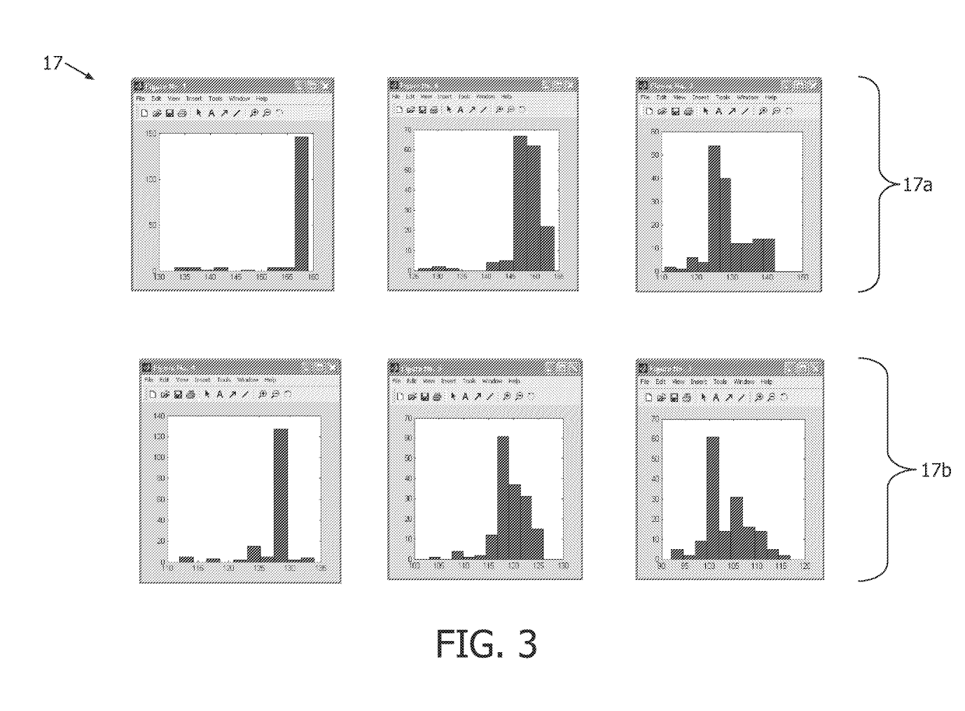

Finally, the bias field can be computed at step 7c. It is possible to set a plurality of regions of interest ROI_1, ROI_2 within the image, and to perform the analysis according to the invention with respect to both ROI's independently (see steps 3, 5; 3′, 5′). Then at step 7 the statistics extracted from ROI_1 and ROI_2 can be compared to each other, providing data input for further analysis, such as bias field estimation. Although in this exemplary embodiment two regions of interest are defined, it is possible to define any plurality of regions of interest. This feature of the method according to the invention is explained with reference to FIG. 3.

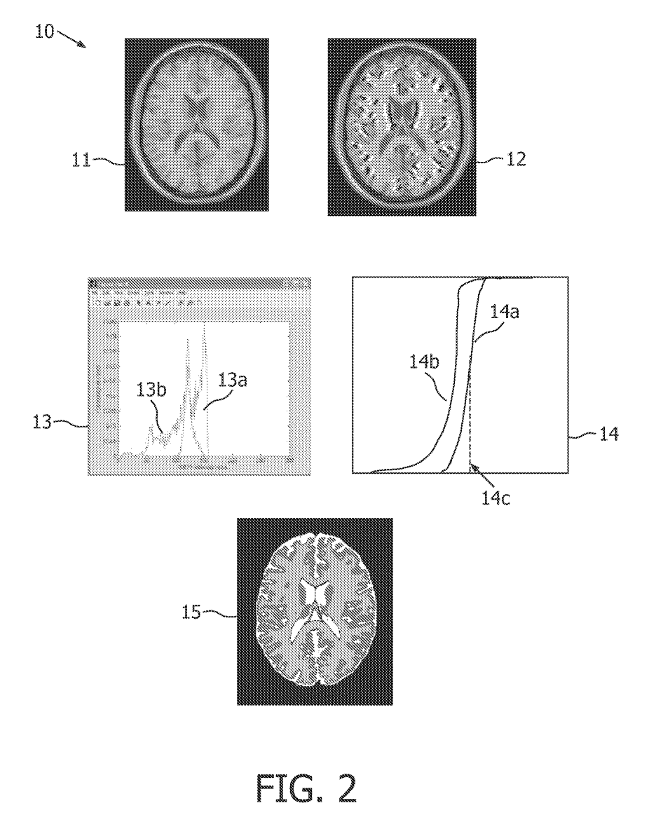

FIG. 2 presents in a schematic way an embodiment 20 of operational steps of the cumulative distribution function. For purposes of this illustration magnetic resonance (MR) image of human brain is selected. Image 11 represents original MR T1 image, while image 12 represents selected voxels that satisfy gradient constraint as well as others. White voxels are candidates for the white matter whereas black voxels are those for grey matter. Respective histograms 13 are computed in accordance with the method of the invention as is set forth in the foregoing. Histogram 13a represents white matter histogram, whereas histogram 13b represents gray matter. Respective cumulative distribution functions (CDF) are given at 14, whereas white matter CDF is given by 14a and gray matter CDF is given by 14b. The corresponding intensity value 14c is computed as being the sought threshold value by using Equation 6 discussed above. The result of the image segmentation using the threshold value 14c is given at 15.

FIG. 3 presents a schematic illustration 17 of the effect of the bias filed on respective histogram peaks. Hereby square blocks of size 24×24 (width-height) by shifting the position of the block each time 8 voxels either in horizontal or vertical direction are applied to the image. For each block, the edge-yielding voxels were determined, and histograms were computed from each of them. In the histograms, peak location ideally corresponds to the tissue intensity. When bias field is present, this peak value should be broadened. Top row 17a indicates the white matter peak location distribution for three datasets whereas the bottom row 17b shows the gray matter peak location distribution for the same dataset. The leftmost plots belong to a dataset with no bias field effect; hence, an isolated and a large peak. The middle column corresponds to a dataset with 10% bias field, whereas the rightmost column with 30% bias field. As the bias field effect increases, the histogram peak becomes less pronounced, and the width gets larger. There can be many metrics to evaluate this widening effect, one is the ratio of the peak height to the total voxels. Depending on this value, one can accept the global threshold, require local analysis, or run a bias field correction algorithm.

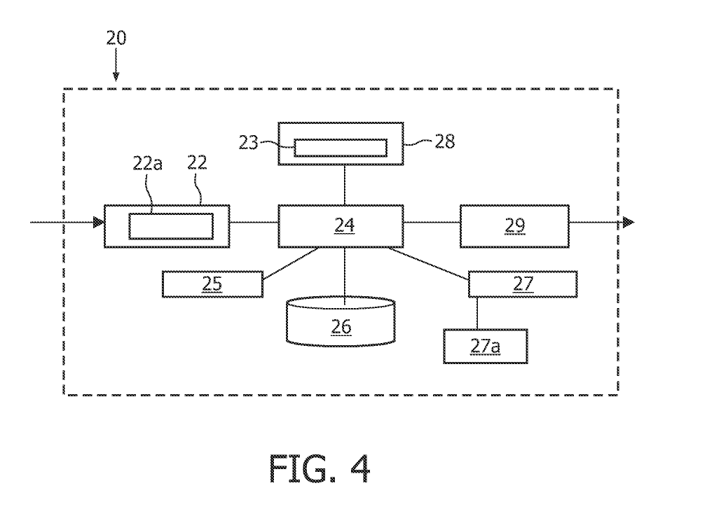

FIG. 4 presents in a schematic way an embodiment of an image processing system according to the invention. The system comprises a computer 20 with an input 22 for receiving a suitable source image data 22a of an object, notably a diagnostic image of a patient, in any suitable form. For example, the computer 20 may be involved in the acquisition of the source image data. In this case the image data may be acquired in an analogue form and converted using a suitable A/D converter to a digital form for further processing. The image data may also be received in a digital form, e.g. through direct acquisition in a digital form or via a computer network after having been acquired by a remote computer/medical instrument. The core of the computer 20 is formed by a processor 24 which is arranged for analyzing the image values for determining edge points and associated gradients. The processor 24 preferably runs a suitable computer routine 25 for this purpose. The computer 20 comprises a storage unit 28 arranged to store any suitable routines to be accessed by the processor during its operation. The computer 20 further comprises a working memory 26, typically based on RAM. The storage unit 28 can be used for storing the image data (or parts of it) when not being processed, and for storing operations on the image data and any other suitable supplementary information, like a predetermined feature 23. The working memory 26 typically holds the (parts of) image data being processed and the instructions for the suitable image processing means used for processing parts of the image data.

The processor 24 is further arranged to classify image values into classes with respect to the edge points. Preferably, a suitable classifier 27 is used, notably in the form of software. The processor 24 is still further arranged to obtain image threshold by combining data from the intensity histograms for each class with statistical analysis of the said histograms. Preferably, this feature is implemented using suitable software 27a, which produces sought results when being initiated by the processor. Preferably, the computer 20 comprises an output 29 which is suitably arranged to provide results of the threshold determination and/or results of image segmentation using the said threshold. Advantageously, the output 29 is arranged to write suitable data into computer readable file.

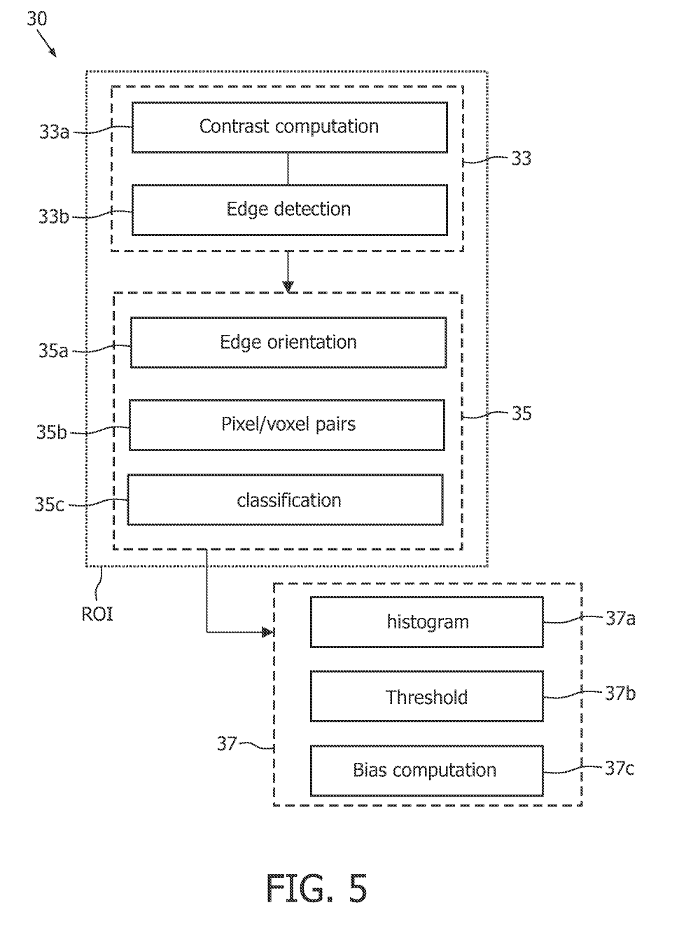

FIG. 5 presents in a schematic way an embodiment of a flow-chart of a computer program according to the invention. The computer program 30 according to the invention comprise instructions to cause a processor to analyze image values (pixels or voxels) of an image under consideration for determining edge points and gradients associated with them following instruction 33. This can advantageously be performed by computing image contrast in accordance with instruction 33a, for example using Equation 1, which is given above. Subsequently, following instruction 33b a suitable edge detector can be used for determining edge points, followed by determination of edge orientation following instruction 35a. Subsequently, suitable pairs of pixels or voxels 35b located at different sides of the edge are selected. In accordance with instruction 35 of the computer program according to the invention the thus selected voxel or pixel pairs are classified, preferably by using a predetermined classification order. For example, a classifying instruction 35c may be used, whereby pixels or voxels are classified into two classes in accordance with their respective absolute magnitude. The computer program 30 according to the invention proceeds to instruction 37, wherein the image threshold is obtained by combining data from the intensity histograms calculated for each class with statistical analysis of these histograms. Preferably, the respective histograms are built by analyzing entries of the two classes of pixels or voxels following instruction 37a. The threshold is then calculated in accordance with the instruction 37b by maximizing a sum of the correct decisions for representative samples that are close to the edge, for example in accordance with Equation 6, discussed above.

Finally, the bias field can be computed in accordance with instruction 37c. It is possible to set a plurality of regions of interest ROI_1, ROI_2 (not shown) within the image, and to perform the analysis according to the invention with respect to both ROI's independently. Then, following instruction 37 the statistics extracted from ROI_1 and ROI_2 can be compared to each other, providing data input for further analysis, such as bias field estimation.

While the invention has been illustrated and described in detail in the drawings and foregoing description, such illustration and description are to be considered illustrative or exemplary and not restrictive; the invention is not limited to the disclosed embodiments.

1. A method (1) for determining a threshold in an image comprising image values, said method comprising the steps of:
analyzing (3) the image values for determining edge points and associated gradients;
classifying (5) image values into classes with respect to the edge points; and
obtaining (7) image threshold by combining data from intensity histograms calculated for each class with statistical analysis of said histograms.

2. A method according to claim 1, wherein the step of analyzing (3) the image values comprises a step of computing image contrast (3 a) and adaptively determining edge gradient threshold to the computed image contrast.

3. A method according to claim 1, wherein the step of classifying (5) image values into classes with respect to the edge points comprises the steps of:
determining edge orientation (5 a) for each edge point;
determining pairs (5b) of values in the image defining said edge points and said edge orientation;
using a pre-defined criterion (5c) to distribute said values into different classes.

4. A method according to claim 3, wherein the step of obtaining image threshold (7) comprises the steps of:
computing normalized intensity histograms (7a) for each formed class;
computing respective cumulative distribution function (7d) corresponding to each class;
determining the image threshold using (7c) said cumulative distribution functions.

5. A method according to claim 4, wherein the image threshold is computed using an optimization function based on said cumulative distribution functions.

6. A method according to claim 1, wherein a predetermined feature is selected for the allowable outcome of the statistical analysis, the method further comprising the steps
of:
computing a plurality of local contrast edges;
classifying image values into classes with respect to said plurality of local contrast edges for forming a plurality of respective local intensity histograms;
obtaining a plurality of local image thresholds by combining data from said plurality of intensity histograms calculated for each class with statistical analysis of said plurality of intensity histograms.

7. A method according to claim 6, wherein a plurality of regions of interests (ROI 1, ROI 2) are defined within the image, the classification of image values being performed for each region of interest and the threshold being established based on analysis of respective histograms and statistics for each selected region of interest.

8. A method according to claim 7, wherein the statistics obtained for the said plurality of regions of interest is used for determining a characteristic descriptive of the image (7c).

9. A method of image segmentation comprising the method for determining a threshold in the image according to claim 1.

10. An image processing system for analyzing an image (22a) comprising image values, said system comprising a computer (20) with a processor (24) arranged for:
analyzing (25) the image values for determining edge points and associated gradients;
classifying (27) image values into classes with respect to the edge points; and
obtaining (27a) image threshold by combining data from intensity histograms for each class with statistical analysis of said histograms.

11. A system according to claim 10, wherein the statistical analysis comprises calculation of a cumulative distribution function for each intensity histogram, the processor being further arranged to compute the image threshold using an optimization function based on said cumulative distribution function.

12. A system according to claim 10, wherein the computer is further arranged to store a predetermined feature (23) for the allowable outcome
of the statistical analysis, the processor being further arranged to:
compute a plurality of local contrast edges;
classify image values into classes with respect to said plurality of local contrast edges for forming a plurality of respective local intensity histograms; and
obtain a plurality of local image thresholds by combining data from said plurality of intensity histograms calculated for each class with statistical analysis of said plurality of intensity histograms.

13. A computer program (30) comprising instructions for causing a processor to carry out the steps of the method according to claim 1.
